(19) United States
(12) Patent Application Publication
(10) Pub. No.: US 2014/0342041 A1
(43) Pub. Date: Nov. 20, 2014

(54) APPARATUS AND METHOD FOR PRODUCING FILTERED AND DISINFECTED WATER

(71) Applicant: NEET Innovations, LLC, Mount Airy, GA (US)

(72) Inventor: Terence F. MULLINS, Quebec (CA)

(73) Assignee: NEET Innovations, LLC, Mount Airy, GA (US)

(21) Appl. No.: 14/279,488

(22) Filed: May 16, 2014

Related U.S. Application Data
(60) Provisional application No. 61/823,967, filed on May 16, 2013.

(51) Int. Cl. B65D 25/14; C02F 1/44; C02F 1/76; C02F 1/50; C02F 1/68

(52) U.S. Cl. CPC B65D 25/14; C02F 1/50; C02F 1/686; C02F 1/766; C02F 1/444; C02F 2303/04; C02F 2103/02
USPC 426/66; 210/638; 210/636; 210/205; 210/201; 206/524.3

(57) ABSTRACT

A combination micro-filtration halogen apparatus safely delivers drinking water by metering doses of concentrated aqueous iodine into a filtered water supply contained within a chamber. Untreated water is poured into the water filter column that allows for gravity to force the water through filters and the filtered or purified water depending on the filters is stored within a lower chamber of the column for disinfection. An aqueous iodine roller metering system controls the amount of iodine dispensed from an aqueous iodine container to the filter column. Turning the roller mechanism accurately meters a selected dose of concentrated aqueous iodine from the iodine container into the lower chamber of the water column. The active residual iodine disinfectant kills microbes in the filtered or purified water making it safe to consume and prevents recontamination. The iodinated drinking water also provides for essential daily human micronutrient requirements.

This application claims priority under 35 USC §119(e) based on provisional patent application No. 61/823,967 filed on May 16, 2013, which is incorporated in its entirety by reference.

### FIELD OF THE INVENTION

A point of use safe drinking water system is disclosed that utilizes micro-filtration and iodine disinfection, particularly for developing countries.

### BACKGROUND ART

Iodine has been used a water disinfectant for over a century. Iodine in a complexed form is used by the military during field operations and outdoorsmen alike to ensure safe small quantities of drinking water from an unknown or a microbial contaminated water source. The level of iodine required to produce safe water (10 ppm) is approved for use by the EPA/FDA on a limited time basis only due to unknown effects of long term use at these levels. For this reason, iodine has not been chosen for long term use to disinfect drinking water in developing countries.

Point of use water systems evolved toward micro-filtration and away from halogen disinfectants over the past several decades. A large majority of these systems simply remove chemical contaminates from water and do nothing to remove bacteria or viruses. The filters that remove bacteria and viruses become clogged quickly; they also require maintenance and expensive filter changes frequently. The water produced by micro-filter systems must be consumed immediately or risk recontamination. Thus, in warm countries, the recontamination of drinking water is a serious issue and renders these types of filters useless. Historically, a level of only 250 ppb iodine in water was considered safe to consume for long term use. This global stance on iodine consumption inhibited its ability to be used effectively as a residual disinfectant.

The World Health Organization increased the safe level of iodine in drinking water to 1 ppm for developing countries around the world. Although 1 ppm is not adequate to create safe water under heavy microbial loading, 1 ppm free iodine is more than adequate to create safe water under post-filtered conditions and providing “free” iodine residuals to inhibit recontamination.

Micro-filtration technologies have changed over the years. A European company produces a micro-filter point of use system using chlorine to disinfect the filter and apparatus with some degree of success. Chlorine is not a viable halogen in developing countries due to its instability under warm weather conditions and varying water chemistry conditions. Thus, a need still exists to provide a drinking water system that is viable under these types of conditions.

With the aforementioned issues regarding the use of iodine, the invention provides solutions to overcome these problems in order to produce a safe and world class point of use iodine water treatment system that would be durable, easy to operate, and reliable over a long period of time. The present invention addresses and surmounts the hereinabove debilitating factors for a point use drinking water system employing iodine as a water disinfectant.

### SUMMARY OF THE INVENTION

It is object of this present invention to provide an apparatus or system and method for producing safe drinking water, preferably for developing countries, by way of pre-filtration and iodine disinfection. Iodine works across a broad range of temperatures and ph conditions. In fact, the warmer the water temperature, the faster iodine destroys micro-organisms. The invention also addresses the difficulty of providing a stable, safe, and inexpensive iodine technology that can easily be transported and have multiple uses under rural conditions in developing countries.

Iodine is a world class disinfectant; it is an essential micronutrient for human life. Aqueous iodine is organic, safe, and stable. Iodine in an aqueous form can be easily contained. However, the container design must be simple, not complicated and function manually without the use of electronics or electricity, if required. Iodine also possesses the ability to pass through plastic and degrades most materials it comes in contact with.

The invention entails both a system and method for providing disinfected drinking water. The system includes a means for filtering contaminated water to down to as low as 0.02 to 1 micron, the means located in a container. An example of this means is gravity column filter that utilizes one or more filters, e.g., two water filtering stages in the upper chamber. The upper chamber within the column provides for the input of the raw water and then, gravity feeds the water through a large particle filter located at the top of the filter column. The particle filter is typically a 100 micron mesh screen filter shaped like a disk, the water passes through the particle filter to the second filtering stage within the upper chamber of the filter column that is a micron filter. The micron filter can be standard hollow fiber filter with micron sizes ranging from 1 to 0.02 depending on the filtration desired. There are several types of micro filters that can be utilized, the hollow fiber filters are preferred and manufactured in many shapes and sizes. The apparatus typically utilizes a column shape filter with flow direction diametrically when using a cylindrical column as either out to in or in to out with back flushing capabilities. The filter is inserted in the upper chamber of the column and is preferably fixed at the center point connecting to the lower chamber within the column. Water passes through the second stage micro-filtration and is collected in the lower chamber of the filter column.

This filtration process is designed to accommodate clear water, if the raw water supply is turbid or muddy then pre-filtration or settling time for the water should be employed.

The system can also optionally include a cap and pump mechanism that can be incorporated onto the leading edge of the water intake of the filter column to increase head pressure and thereby increase the filter rate process.

During the water filtering process, aqueous iodine is introduced into the lower chamber to provide disinfection. To accomplish this aim, a source of aqueous iodine is provided, e.g., 300 mg/l concentrated aqueous iodine is stored in a container adjacent to the column. The aqueous iodine is dispensed through an “iodine tube” connected to the container, e.g., a T-pac or iodine bag, inside the container, and the tube is inserted into the lower chamber of the column. A metering roller system is associated with the iodine delivery tube within or without a housing enclosing the iodine container or bag, hereinafter the bag.

With a turn of the roller mechanism, aqueous iodine is introduced in a predetermined amount, preferably for drinking water, e.g., 1 mg/liter, into the filtered water in the lower chamber.

This metering task can also be accomplished by several conventional tube rolling systems, both manual and electric. Peristaltic pumps are a classic example of metering tube roller systems. Due to the corrosive nature of iodine, the chemical free handling aspect of a peristaltic type system is the preferred method of dispensation. This is considered a means for adding a metered amount of iodine to filtered water held in the container for producing disinfected water in the container. Since peristaltic pumps are well known, the precise details of these systems are not necessary for understanding of the invention. Suffice to say, these systems can be readily designed to produce a particular amount of a solution for a given use. In the present invention, the roller system is used to produce the desired amount of iodine solution to make drinking water. Alternatively, a larger amount of the iodine solution can be dispensed for other iodine solution applications like disinfecting fruits and vegetables and treating cuts, scrapes, and the like.

A means for accessing the filtered and disinfected water or making it available is provided on the container, e.g., a tap is provided to dispense filtered and disinfected safe drinking water on the lower portion of the filter column.

The invention also includes the provision of cleaning and disinfecting the filter media. To accomplish this, the iodine tube is disconnected from the column. With an amount of iodinated water remaining in the lower chamber, e.g., 10% to 25%, the column is removed from its mounting brackets and inverted. A shaking of the column vertically is performed to force water in the reverse direction through the filters. This process cleans and clears the filters and disinfects the upper chamber of the water filter column.

Another mode of the invention is the use of a bag of iodine solution with two tubes and two roller metering systems. In this embodiment, one tube and one roller system can be used to provide the correct amount of iodine solution for the drinking water. The other tube and corresponding roller system can be designed to dispense a large dose of iodine solution, e.g., one that would create a 5 ppm iodine concentration for a liter of water. This dispensed dose can be directed to a container containing a liter of water and the iodinated water can be used for disinfecting fruits and the like, treating cuts and scrapes and other applications that can use a higher concentration of iodine solution. Of course, the system and method could also be designed to produce the higher concentration of iodine solution in the filter column using a larger tube size and corresponding roller system for producing iodinated water for uses other than drinking water.

The invention also includes a unique storage bag for the iodine solution. The bag is designed so that its interior is resistant to degradation when holding the iodine solution as the iodine solution is not compatible with a mere plastic. A Teflon inner layer of the bag accomplishes this aim. The bag can also have a v-shape at the bottom with the tube for dispensing the iodine solution located at the very bottom of the bag to ensure that the iodine solution can be completely used for its intended purpose. The tube or tubes are made of a material that does not degrade when in contact with the iodine solution. If two tubes are used, each would be located at the most bottom part of the bag. A bag is used so that there is no requirement for venting of the container holding the solution. Any venting of a rigid container poses a risk in that oxygen can enter the container, thus adversely affecting the iodine therein and provide an outlet to atmosphere of iodine in the container, which also is disadvantageous. The bags can be reused so save on costs and environmental effects.

### BRIEF DESCRIPTION OF THE DRAWINGS

FIG. 1 shows a water filter column for use in filtering and disinfecting water using iodine.

FIG. 2 shows an iodine container to be used to add iodine to filtered water in the column of FIG. 1.

FIG. 3 shows an iodine bag to be used in the container of FIG. 2.

FIG. 4 shows a cap and hand pump for increase the filtering rate of the column of FIG. 1.

FIG. 5 shows a system including the components of FIGS. 1-4.

### DETAILED DESCRIPTION OF THE INVENTION

As a part of the invention, an apparatus is provided to safely deliver drinking water by metering doses of concentrated aqueous iodine into a pre-filtered water supply contained within a chamber. Untreated water is poured into the holding container column that allows for gravity to force the water through filters that remove particles and microbials from 1 micron to 0.02 microns; the filtered water is stored within a lower chamber of the column. The stored filtered water is retained for disinfection. An aqueous iodine roller metering system by way of an iodine drop tube is attached to an aqueous iodine container or bag. The bag has an iodine drop tube with selected tubular dimensions to match a roller wheel system dimensions. The iodine drop tube is inserted into the lower chamber of the water container or column. Turning the roller mechanism squeezes the iodine drop tube and accurately meters a selected quantity of concentrated aqueous iodine from the iodine container into the lower chamber. The active residual iodine disinfectant kills microbes in the filtered water, thus making it safe to consume and prevents recontamination. The iodinated drinking water also provides for essential daily human micronutrient requirements.

To clean the filters within the water container column, the iodine tube is removed from the water container. With an appropriate amount of water, e.g., 10% to 25%, of treated water in the lower chamber of the water container, the water container column is removed from its mounting and inverted. The water container column is shook to force water in the reverse flow direction through the filtration system to remove debris from the filters. This process also disinfects the filters and the upper chamber of the water column.

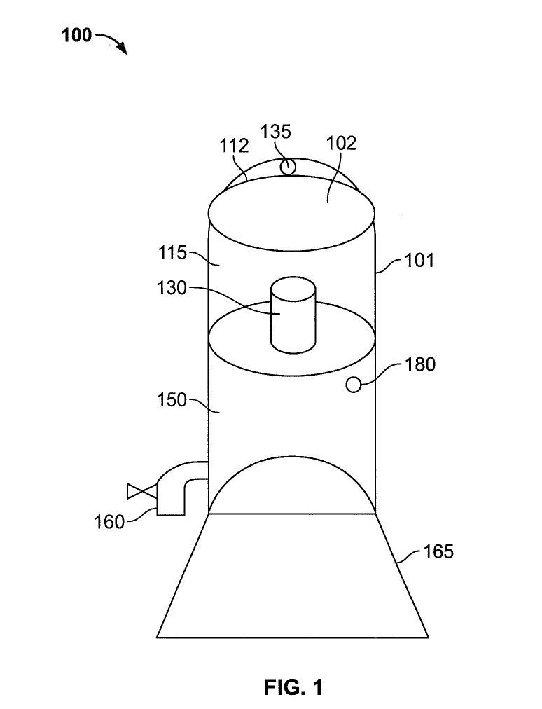

One mode of the invention is described in FIGS. 1-5, which are described as follows. With reference to FIG. 1, a water filter column apparatus is represented by reference numeral 100. The filter column apparatus 100 includes a column 101, which can be fabricated from rigid or flexible polyvinylchloride or a similar plastic. The dimension of the column 101 can vary but a preferable size is 4 inches in diameter and two feet in length so as to contain and filter approximately one (1) gallon of water. Of course, the filter column 101, designed for filtering and disinfecting water could be made from any material and other sizes depending on the amount of disinfected water desired. While a cylindrical column is shown, other shapes could be employed.

The water filter column 101 has an intake 102 and raw water can be poured in from the top of the column 101 at the intake 102.

The apparatus 100 includes a large particle filter 112. An example of such a filter is one with a rating of 100 microns. The filter 112 is located in the upper chamber or portion 115 of the column and serves as a pre-filter to remove large particles prior to entering a second filter 130, e.g., a hollow fiber micron filter. A standard column shaped hollow fiber filter 130 is sized for the system and flow rate requirements with an end micron size filter. A target for filtering ranges from 1 micron to as low as 0.02 microns, and preferably as low as 0.02 microns.

The filter can be fixed to the center point of the filter column 101 so that all water passing to the lower chamber 150 must pass through the hollow fiber filter 130 to get to the lower chamber. While the flow through the filter 130 can be any direction through the filter, a preferred flow direction would encompass from in to out or out to in. That is, the filter is configured so that the filtered water enters a center part of the filter and moves outwardly and then out or the water enters a peripheral part of the filter and moves inwardly and then out. The filtering should be such that it removes a sufficient amount of unwanted components from the water that the resulting filtrate, which enters the lower chamber 150, when receiving the dispensed iodine solution, e.g., 1 ppm concentration solution, is safe for drinking. It is believed that the range of filtering set forth above can accomplish this aim. However and depending on the quality of the water being disinfected, additional filtering may be required or the micron size of the filters may have to vary. For example, the filtering can be at a level that removes sufficient microbials and other impurities so that the filtered water, when combined with a concentrated iodine solution to produce a 1 ppm final iodine concentration in the filtered water, for example filtering to 0.02 to 1.0 micron, preferably to 0.02 microns, is drinkable.

The lower chamber 150 of the column is designed to retain, disinfect, and dispense safe drinking water. The bottom 165 is provided for the column 101. The bottom 165 caps and seals the column 101 and a water spigot 160 or other means is provided to make the disinfected water available. The spigot 160 can be inserted on a side or the bottom of the column to access water in the lower chamber 150. The lower chamber 150 within the column 101 has an access hole 180 in the column 101 just below the midway point, but other locations on the column 101 can be used. The hole 180 provides an insertion point for an iodine disinfectant delivery tube, which is part of the means for adding the iodine to the filtered water for disinfection.

The lower chamber 150 will naturally absorb iodine until the iodine demand of the plastic used to make the column 101 and lower chamber 150 is met. To eliminate this demand process, the lower chamber 150 can be iodine impregnated during the manufacturing process, which is a well known process and requires no further explanation for understanding.

In another embodiment of the invention, the upper chamber 115 can be detached and raised to increase the head pressure and increase the gravity feed process. In this embodiment of the invention the upper and lower chambers 150 and 115, respectively, are connected with a tube (not shown) to allow water flow between chambers 115 and 150.

The bottom or base cap 165 can be plastic and can be configured as a stand as a means for supporting the water filter column 101, if desired.

As an alternative for supporting the apparatus 100, a mounting hook hole 135 at the top of the column 101 can be provided and function as another means for mounting or supporting. This enables the apparatus 100 to be hung from a hook.

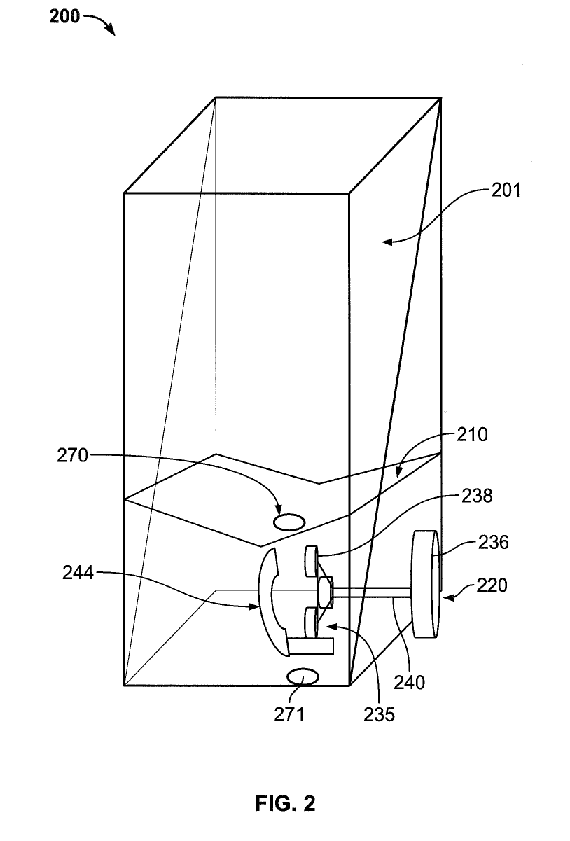

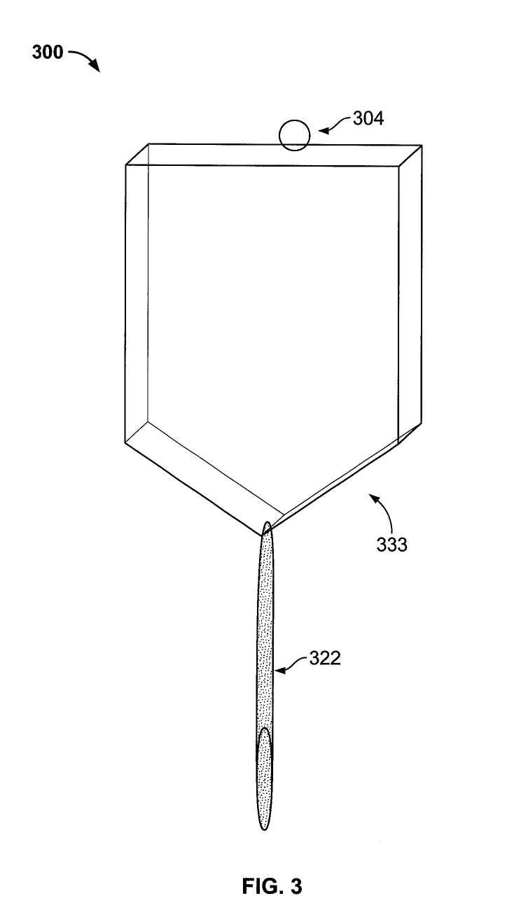

FIGS. 2 and 3 shows the iodine dispenser that is designed to provide a metered amount of iodine to the apparatus 100 for disinfection of the filtrate contained in the lower chamber 150. The dispenser is designated by the reference numeral 200 and includes an iodine housing 201. The housing 201 is preferably a lightweight UV protected plastic housing to house an iodine bag 300, see FIG. 3, and the tube roller system 220 contained within the housing 201. The bag and tube roller system operation are described below.

As an example of the housing 201, the housing can be configured to open from the front of the housing to allow for easy maintenance and product replacement.

Of course, the bag 300 and tube roller system 220 could be associated with the column 101 without any housing, if so desired, and could be supported in any known way to allow feed to the column 101.

The iodine housing 201 can accommodate a single roller system or several iodine roller systems and iodine tubes to deliver different quantities of iodine with a single rotation of the wheels for diverse disinfection applications.

The housing 201 is provided with an iodine bag support platform 210 to support the bag 300. The platform is preferably V-shaped, and preferably fabricated from sheet plastic to accept and retain the iodine bag 300 during storage and operation. However, any type of support could be used to hold the iodine bag 300 during storage and operation.

The dispenser is also equipped with a first opening 270 to allow the bag 300 to interface with the tube roller system 220 and a second opening 271 to allow metered iodine to exit the tube roller system and be added to the lower column 150 via the hole 180.

The first opening 270 is located in the iodine bag support platform 210 and is strategically located to allow pass through of an iodine tube 322 attached to the iodine bag 300, see FIG. 3. The second opening 271 is located in a bottom of the housing 201 and is also strategically located in conjunction with the first opening 270 to align the iodine tube 322 with the roller wheel assembly 235.

The tube roller system 220 includes a tube lock plate 244, roller wheel assembly 235 for squeezing the tube 322, and a roller handle 236.

A locking plate 244 holds the iodine tube 322 in place to allow the wheels 238 of the roller wheel assembly 235 to squeeze the tube 322 during operation and restrict the fluid flow when the system is not in use.

The roller wheels 238 squeeze tube 322 and are sized and spaced according to tube size and the desired metered fluid dose per revolution of the wheels. Wheel assemblies can be three, four or five wheels in the roller wheel assembly 235. As an example, a three wheel system is illustrated.

The roller handle 236 is attached to a shaft 240 that interconnects with a roller wheel assembly 235. The roller handle 236 is sized based on specific metered fluid doses delivered by one full rotation of the handle.

Continuing to refer to FIGS. 2 and 3, the iodine bag 300 is shown in FIG. 3. The bag is designed as a refillable insert that can be repeatedly filled with an iodine concentrate. Preferably, the bag 300 is a teflon/kynar fluoropolymer bag For example, a malleable clear or opaque plastic bag coated with a Teflon interior is shown. Again, the bags would be sized according to a desired fluid volume.

The bag, while having any shape, preferably has a v shape that allows complete or near complete drainage of the retained aqueous iodine in the bag. The bags 300 can be made of supple collapsible durable materials, thus avoiding the need for venting and the problems that venting can cause, iodine escape to the atmosphere and oxygen entry into the iodine bags. The bags can be designed to be reused and refilled.

The tube 322 is a hose made from a chemically inert material. As an example, viton rubber is preferred.

The bag has a mounting aperture 304, which allows the iodine bag 300 to be mounted to the housing 201.

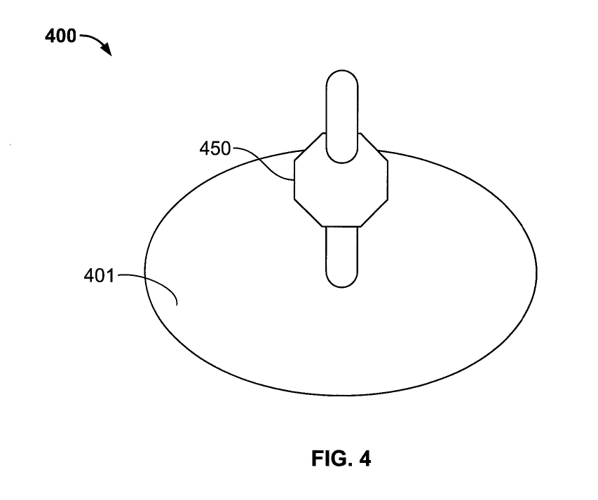

FIG. 4, illustrates a cap and hand pump assembly 400 for the apparatus 100. The assembly 400 includes a container cap 401, which is configured to be sealably attached to the top of the column 101. A hand pump 450 is provided and attached to the cap 401 so that it is in communication with the interior of the column 101 when the cap 401 is sealably attached thereto. By operating the hand pump 450, an operator can increase the pressure in the column 101, which, in turn, increases the filtering rate through the filters.

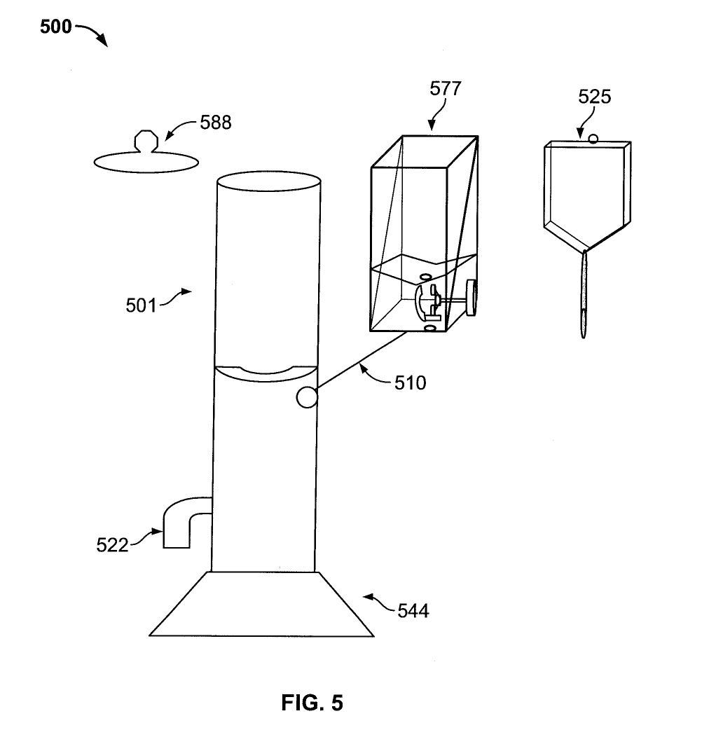

FIG. 5 shows the components of FIGS. 1-4 illustrated together as a complete system for filtering and disinfecting raw water. This exemplary system is represented by reference numeral 500, and includes a water filter column 501, a water spigot 502, an iodine dispenser 577, an iodine bag 525, a column base support 544, and a cap and pump assembly 588. The line 510 represents the tube of the bag 525 and its interfacing with the column 101 to feed the metered amount of iodine to the column for water disinfection.

In operation and referring to FIGS. 1-4, the filter column 101 can be fabricated to contain and filter approximately 1 gallon of water. Water is poured in from the top of the column 101 and through the large particle filter 112 to remove large particles prior to entering the hollow fiber micron filter 130. The filter 130 is preferably fixed to the center point of the filter column 101 so that all water passing to the lower chamber 150 must pass through the hollow fiber filter 130. The filtering should be such that it removes a sufficient amount of unwanted components from the water that the resulting filtrate, when receiving the dispensed iodine solution, e.g., 1 ppm concentration solution, is safe for drinking.

The lower chamber 150 of the column 101 retains, disinfects and dispenses safe drinking water by the ability to receive the iodine from the iodine bag 300 in the correct amounts and the spigot 160

For disinfection, the hole 180 receives the iodine disinfectant delivery tube 322, which is part of the means for adding the iodine to the filtered water for disinfection.

To dispense the iodine solution from the bag 300, the iodine bag can be stored in the housing or in some other location if so desired. The housing 201 can house for the iodine tube roller system 220 and its various components and/or the bag 300. The holding plate 210 can be used in the housing 201 for the bag 300 if so desired. If the holding plate 210 is used, the tube 322 is inserted through the opening 270, through the tube roller system 220 and through the opening 271. The tube 322 extending from the opening 271 is inserted through the hole 180 so that iodine solution can be added to the water in the lower chamber 150.

Once the tube 322 is inserted into the hole 180 and the filtered water is in the lower chamber 150, the tube roller system is operated to dispense a measured amount of iodine into the lower chamber to disinfect the water therein. The disinfected water can be then accessed by the spigot 160.

To clean the system, the iodine tube 322 is removed from the hole 180, and the column 101 is inverted and shook vigorously for a predetermined period of time, e.g., several seconds. The reverse water flow through the filters 130 and 112 and dislodges debris, disinfects the filters, and the upper chamber 115 of the column 101. There should be sufficient water in the lower chamber 150 to permit the filters to be backflushed and disinfected, and to permit the upper chamber 115 to be disinfected. A preferable amount of iodinated water would range between 10% and 25% of that found in the lower chamber 150 during the cleaning process, but other amounts may work depending on the filtering system and size of the column.

The tube roller system 220 of the invention provides a number of advantages. In places where there is no electricity, it permits a manual dispensing of the necessary iodine solution. It also provides a simple control wherein one revolution of the wheel or knob of the system produces the desired dose of the concentrated iodine solution.

With reference to FIG. 3, an example of the a means for adding a metered amount of iodine to the filtered water held in the container for producing disinfected water in the container is the manual roller system as reference numerals 235, 236, 238, 240, and 244, which is considered a chemical-free operating delivery system. The roller design apparatus is based on the principles of peristaltic pump design. The iodine tube 322 of the iodine bag 300 is mounted and secured in place along the curved locking plate 244, whereby roller wheels revolve and compress the tube against the locking plate to deliver metered quantities of liquid product. The apparatus is a multi-roller wheel hub design with a connecting shaft, a tube retention plate and hand turning mechanism 236, 240. The relationship between the wheel size and the tube size is well understood for metering a fluid. Based on the rollers making a single turn and squeezing the tube in the roller process, a known quantity of aqueous iodine is delivered through the tube.

As noted above, the iodine bags can employ two tubes, one sized for the drinking water application and the other designed to produce an iodine solution of higher concentration, e.g., 5 ppm. In this mode, the iodine bag could have a pair of tubes and there would be two metered roller systems. One tube and roller system would be employed for the drinking water application. The other tube and roller system would be employed to produce a metered amount of the iodine solution for an application that permits higher iodine concentrations. For example, the other tube and roller system would be sized and designed to produce a one liter amount of water having 5 ppm concentration of iodine. This could be accomplished by merely dispensing enough concentrated iodine solution to make a 5 ppm concentration in a liter of water. This water could be used for disinfecting fruit and vegetables and treating cuts and scrapes. While the one tube would be sized to enter the column 101 for disinfected water making, the other tube could just freely extend from the bag and be directed by the user to a particular container. For example, a bucket with one liter of water could receive the metered dose of iodine solution from the free tube for the applications described above or others that could employ higher concentrations of iodine. It should also be understood that the system could produce a solution with a higher iodine concentration than that used for drinking water. In this instance, the tap of the column could dispense the iodine solution for purposes other than drinking, fruit/vegetable disinfection, medical uses, and the like.

The roller mechanisms can be mounted within or without the iodine bag housing. The roller mechanism will typically deliver 3.78 milliliters of 300 ppm/l aqueous iodine with a single rotation of the hand turning mechanism. This when mixed with the water in the container produces a 1 ppm concentration of iodine in the drinking water. For the two tube design of the iodine bag, the roller mechanism could deliver 5 times this amount to produce the 5 ppm concentration in a liter of water.

Where power is available, a traditional electric peristaltic pump can also be utilized to accomplish the required task of metering the aqueous iodine solution into the lower chamber of the water filter column.

Of course, other metering devices or systems can be employed that would be capable of delivering or dispensing the required amount of iodine from the bag or other container holding the aqueous iodine solution, whether strictly mechanical and without the need for power or one that can use available electricity for operation. The iodine solution in the bag would also include additives such as vitamins, minerals, or other nutrients to supplement the disinfected drinking being supplied for consumption. While any known vitamins, minerals, and nutrients can be used in connection with the invention, preferred vitamins include C because it helps the body absorb iodine then E because it assists iodine in the healing process of skin. For minerals, iron, calcium, selenium (helps with thyroid function so iodine can function in its intended manner), chromium zinc and so on. The amounts of the additives would be in effective amounts to satisfy the consumption of the additive. For example, vitamins could be added so that the consumer of the disinfected water receives the recommended daily allowance or a portion thereof. Similar dosing could be used for minerals and other nutrients. An example of listing of vitamins and minerals can be found at http://www.cdc.gov/nutrition/everyone/basics/vitamins/, which is incorporated by reference herein.

It is difficult to control pure liquid iodine while being stored in the presence of other reactive minerals and vitamins. So the integrity of the iodine as a biocide is essential with no interference, once that disinfection is accomplished there is no issue adding micro doses of these vitamins and minerals with the device and blending these vitamins and minerals in the water vessel prior to consumption. As such, the vitamins and minerals can be added to the disinfected water prior to dispensing and this can be done in any way, for example, having another port in the column to add the desired vitamin and/or mineral in powder or liquid form and in the appropriate amount based on the amount of disinfected water being treated.

Features of the invention include the following:
a) An apparatus that comprises a cylindrical plastic column with filter media to remove particles and microbes down to 0.02 microns.
b) An apparatus plastic cylinder column with 2 chambers.
c) An apparatus plastic cylinder column with 2 stage filtration.
d) An apparatus comprising a plastic cylinder column with filtration in the upper chamber and water disinfection in the lower chamber.
e) An apparatus that is a plastic cylinder column with water retention capabilities in the lower chamber.
f) An apparatus that is a plastic cylinder column that has a lower chamber that is iodine impregnated.
g) A plastic cylinder column that can accept aqueous iodine in a concentrated form.
h) A plastic cylinder column that can be inverted and shaken to clean and disinfect the filters.
i) A plastic cylinder column that can be self disinfected during a shaking process.
j) An apparatus with a filter media that can be cleaned and disinfected during the shaking process.
k) An apparatus that can accommodate a palm hand pump and cap system mounted on the top of the plastic cylinder column to increase pressure within the upper chamber of the plastic cylinder column to increase filtering rates.
l) An apparatus that includes a container to house an aqueous iodine bag and is one that is preferably fabricated from plastic or metal and preferably opens from the front.
m) An apparatus that includes a housing that accommodates a single or multiple roller systems, that can be mechanical or manual, electrical or the like.
n) An apparatus having a housing with an angled mounting plate to retain the iodine bag within the housing and having an aperture strategically located in the plate to accept the iodine tube.
o) A method of iodine dispensation and an apparatus that functions as a hand operated roller system mounted within or without a system to deliver metered doses of aqueous iodine.
p) A method to store, ship and dispense iodine by way of a chemically inert Teflon coated V shaped plastic bag.
q) A chemically inert rubber tube attached to the iodine bag and sized for the roller system.

As such, an invention has been disclosed in terms of preferred embodiments thereof which fulfills each and every one of the objects of the present invention as set forth above and provides a new and improved apparatus and method for supplying disinfecting water for drinking and other uses.

Of course, various changes, modifications and alterations from the teachings of the present invention may be contemplated by those skilled in the art without departing from the intended spirit and scope thereof. It is intended that the present invention only be limited by the terms of the appended claim.

I claim:

1. A method of providing disinfected water comprising the steps of:
filtering contaminated water to a level that removes sufficient microbials and other impurities to make filtered water so that the filtered water, when combined with a concentrated iodine solution to produce a 1 ppm final iodine concentration in the filtered water, for example filtering to 0.002 to 1.0 micron, preferably to 0.02 microns, is drinkable, and collecting the filtering water into a container;
providing a source of iodine; and
adding a metered amount of iodine to the container to produce the disinfected water having an iodine concentration of not more than 1 ppm.

2. The method of claim 1, wherein the adding step does not use any electric power.

3. The method of claim 1, wherein the source of iodine is provided in a bag having a dispensing tube and the dispensing tube is manipulated to produce the metered amount of iodine

4. The method of claim 1, wherein the disinfected water is made accessible from the container for use.

5. The method of claim 3, further comprising the step of providing at least two different metered amounts of iodine solution, one metered amount used for said water disinfection and a second and larger metered amount for use in applications such as disinfecting fruits or vegetables, or treating cuts and scrapes or the like.

6. The method of claim 1, further comprising a cleaning step, wherein filters used for the filtering step are backwashed and disinfected using disinfected water produced in the container.

7. A system for providing disinfecting water comprising:
a container for holding water;
a means for filtering contaminated water to a level that removes sufficient microbials and other impurities to make filtered water so that the filtered water, when combined with a concentrated iodine solution to produce no more than a 1 ppm final iodine concentration in the filtered water, for example filtering to 0.02 to 1.0 micron, preferably to 0.02 microns, is drinkable, and collecting the filtering water into the container;
a means for adding a metered amount of iodine to the filtered water held in the container for producing disinfected water in the container; and
means for making the disinfected water available from the container.

8. The system of claim 7, wherein the means for filtering further comprises a plurality of filters.

9. The system of claim 7, wherein means for adding further comprising a source of iodine solution.

10. The system of claim 9, wherein the source of iodine solution comprises a bag having at least one dispensing tube in communication with the container having the filtered water therein.

11. The system of claim 10, wherein the adding means further comprising a roller metering system having rollers interfacing with the at least one dispensing tube to add the metered amount of iodine to the filtered water.

12. The system of claim 11, the adding means includes a housing for holding the bag and/or the roller metering system.

13. The system of claim 7, wherein the container includes a means to increase the pressure therein to increase a filtering rate, wherein the means can includes a pump mechanism.

14. The system of claim 7, wherein the adding means is one that is purely mechanical and uses no electric power or is one that uses electric power.

15. The system of claim 11, wherein the bag has at a pair of dispensing tubes, and a pair of roller metering systems are provided, with each tube thereof sized to dispense a different amount of iodine using a respective roller metering system.

16. An iodine solution carrying bag system for use in disinfecting water comprising:
a bag having a teflon inner coating to protect the bag for degradation by an iodine solution contained therein;
at least one tube, with one end sealably connected to a bottom of the bag, the other end of the at least one tube being a free end that is closed to keep the iodine solution in the bag and tube until the tube is used with a roller metering system at which time, the tube end can be opened for dispensing of the iodine solution using the roller metering system, the tube made of a material that is resistant to degradation by the iodine solution, wherein the bag is sized to be filled completely with the iodine solution.

17. The bag of claim 16, wherein the bottom of the bag is v-shaped.

18. The bag of claim 16, comprising a pair of tubes, with each tube sized to dispense a different amount of iodine in solution.

19. The method of claim 1, wherein the disinfected water includes an effective amount of one or more minerals and vitamins.
